(19) United States
(12) Patent Application Publication
(10) Pub. No.: US 2009/0132527 A1
(43) Pub. Date: May 21, 2009

(54) PERSONALIZED VIDEO CHANNELS ON SOCIAL NETWORKS

(75) Inventors: Mithun SHESHAGIRI, Mountain View, CA (US); Simon J. GIBBS, San Jose, CA (US); Phuong NGUYEN, San Jose, CA (US); Priyang RATHOD, Mountain View, CA (US); Anugeetha KUNJITHAPATHAM, Sunnyvale, CA (US)

Correspondence Address: Beyer Law Group LLP, P.O. BOX 1687, Cupertino, CA, 95015-1687, US

(73) Assignee: SAMSUNG ELECTRONICS CO., LTD., Suwon City (KR)

(21) Appl. No.: 12/348,629

(22) Filed: Jan. 5, 2009

Related U.S. Application Data
(63) Continuation-in-part of application No. 12/120,217, filed on May 13, 2008.
(60) Provisional application No. 60/989,413, filed on Nov. 20, 2007.

(51) Int. Cl. G06F 7/06; G06F 17/30

(52) U.S. Cl. 707/5; 707/E17.108; 707/E17.046

(57) ABSTRACT

In a first embodiment of the present invention, a method for automatically creating a list of media items for a user is provided. Information relating to the user is obtained from a social networking site. One or more keywords are then extracted from the information. The one or more keywords are then sent to a media item search engine. A list of media items relating to the keywords are received from the media item search engine.

### CROSS REFERENCE TO RELATED APPLICATION

This application is a Continuation-in-Part of U.S. patent application Ser. No. 12/120,217 (Attorney Docket No. SISAP022/CSL07-NW15), filed on May 13, 2008, entitled “SYSTEM AND METHOD FOR AUTOMATICALLY RATING VIDEO CONTENT,” which claimed priority to Provisional Patent Application No. 60/989,413 (Attorney Docket No. SISAP017P/CSL07-NW14-PRO), filed on Nov. 20, 2007 entitled “A PERSONALIZED VIDEO RECOMMENDER SYSTEM” by Gibbs et al., all of which are hereby incorporated by reference in its entirety and for all intents and purposes.

### FIELD OF THE INVENTION

The present invention generally video channels. More specifically, the present invention relates to automatic creation of video channels on social networks.

### BACKGROUND OF THE INVENTION

There is a vast amount of video media available to the consumers. From films or movies to broadcast television programs to cable or satellite television programs to home movies or user-created video clips, there are many repositories, databases and other sources from which the consumers may choose and obtain video media in various formats. The amount of video media available to the consumers continues to grow at a very high rate. Broadcast, cable, or satellite companies often provide hundreds of different channels for the consumers to choose from. Movie rental companies such as Netflix and Blockbuster have tens, even hundreds, of thousands of titles on DVDs (digital video disc) or video cassettes. More recently, the Internet has also lent its unique capability and become a great repository and distribution channel for video media world-wide. Sites such as YouTube have immense video collections, often millions of video clips, contributed by users from all over the world.

Of course, the content of these videos vary greatly. As a result, finding and organizing the videos can be challenging, especially individual users who typically must utilize search queries to retrieve videos of interest. One challenge, however, is that oftentimes it can be difficult for a user to think of a particular interest to view at any particular point in time, or has trouble thinking of an appropriate keyword even if a particular interest comes to mind. For example, while sometimes a user will know exactly what type of video he is in the mood to watch, user viewing habits oftentimes are more closely tied to the traditional television channel viewing system, where third parties select the lineup and the users merely passively select which shows to watch by selecting a channel (i.e., agreeing or disagreeing with a network programmers choices, as opposed to having to come up with the choices for him or herself).

A social network service uses software to build online social networks for communities of people who share interests and activities or who are interested in exploring the interests and activities of others. These online networks are often referred to as social networking sites.

Most services are primarily web based and provide a collection of various ways for users to interact, such as chat, messaging, email, video, voice chat, file sharing, blogging, discussion groups, and so on. Various social networking websites are being used by millions of people everyday on a regular basis and it now seems that social networking is a part of everyday life.

The main types of social networking services are those which contain directories of some categories (such as former classmates), means to connect with friends (usually with self-description pages), and recommender systems linked to trust. Popular methods now combine many of these, with MySpace and Facebook being the most widely used in North America, Bebo, MySpace, Skyblog, Facebook and Hi5 in parts of Europe, Orkut and Hi5 in South America and Central America, Friendster, Orkut and CyWorld in Asia and the Pacific Islands and LiveJournal in Russia.

In general, social networking services allow users to create a profile for themselves, and can be internal or external. Both types can increase the feeling of community among people. An Internal Social Network (ISN) is a closed/private community that consists of a group of people within a company, association, society, education provider and organization or even an “invite only” group created by a user in an External Social Network (ESN). An ESN is open/public and available to all web users to communicate and are designed to attract advertisers. Users can upload a picture of themselves and can often be “friends” with other users. In most social networking services, both users must confirm that they are friends before they are linked. For example, if Alice lists Bob as a friend, then Bob would have to approve Alice's friend request before they are listed as friends. Some social networking sites have a “favorites” feature that does not need approval from the other user. Social networks usually have privacy controls that allows the user to choose who can view their profile or contact them, etc.

Some social networks have additional features, such as the ability to create groups that share common interests or affiliations, upload videos, and hold discussions in forums. Geosocial networking co-opts internet mapping services to organize user participation around geographic features and their attributes.

Few social networks currently charge money for membership. In part, this may be because social networking is a relatively new service, and the value of using them has not been firmly established in customers' minds. Companies such as MySpace and Facebook sell online advertising on their site. Hence, they are seeking large memberships, and charging for membership would be counter productive. Some believe that the deeper information that the sites have on each user will allow much better targeted advertising than any other site can currently provide. Sites are also seeking other ways to make money, such as by creating an online marketplace (e.g., Facebook's Marketplace) or by selling professional information and social connections to businesses, such as LinkedIn.

Social networks operate under an autonomous business model, in which a social network's members serve dual roles as both the suppliers and the consumers of content. This is in contrast to a traditional business model, where the suppliers and consumers are distinct agents. Revenue is typically gained in the autonomous business model via advertisements, but subscription-based revenue is possible when membership and content levels are sufficiently high.

### SUMMARY OF THE INVENTION

In a first embodiment of the present invention, a method for automatically creating a list of media items for a user is provided. Information relating to the user is obtained from a social networking site. One or more keywords are then extracted from the information. The one or more keywords are then sent to a media item search engine. A list of media items relating to the keywords are received from the media item search engine.

In a second embodiment of the present invention, an apparatus for automatically creating a list of media items for a user is provided, the apparatus comprising: a personalized channel builder communicatively coupled to a video search engine and to a social networking site, the personalized channel builder comprising: a profile extractor; and a channel distributor.

In a third embodiment of the present invention, another apparatus for automatically creating a list of media items for a user is provided, the apparatus comprising: means for obtaining information relating to the user from a social networking site; means for extracting one or more keywords from the information; means for sending the one or more keywords to a media item search engine; and means for receiving a list of media items relating to the keywords from the media item search engine.

In a fourth embodiment of the present invention, a program storage device readable by a machine tangibly embodying a program of instructions executable by the machine to perform a method for automatically creating a list of media items for a user is provided, the method comprising: obtaining information relating to the user from a social networking site; extracting one or more keywords from the information; sending the one or more keywords to a media item search engine; and receiving a list of media items relating to the keywords from the media item search engine.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an architecture for creating a personalized video channel in accordance with an embodiment of the present invention.

FIG. 2 is a flow diagram illustrating a method for automatically creating a list of media items for a user in accordance with an embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that this description is not intended to limit the invention to the described embodiments. To the contrary, the description is intended to cover alternatives, modifications, and equivalents as may be included within the spirit and scope of the invention as defined by the appended claims.

The present invention leverages the fact that users spend considerable time on social networking sites in defining their identity, interest, tastes, and friends. They also spend considerable time updating their profiles, resulting in very fresh information being available from social networking site profiles. In an embodiment of the present invention, information such as “profile information” is used to identify videos of interest to the user. A customized video channel may then be created based upon this information, allowing the users to view the videos as a package when logging in to their personalized page on a social network.

According to various embodiments, systems and methods for automatically creating a personalized video channel based upon information from a social network are provided. A media device is capable of supporting various video operations, such as viewing, recording, downloading, or uploading videos. The media device may be a consumer electronic device, such as a television, including CRT (Cathode ray tube), projection, LCD (liquid crystal display), plasma, or high-definition televisions, a video recorder and/or player, including VCRs (video cassette recorder), PVRs (personal video recorder), or DVRs (digital video recorder), a cable or set top box, an audio/video controller, etc. The media device may also be a mobile or personal media player or a personal computer. The media device may also be a cellular telephone.

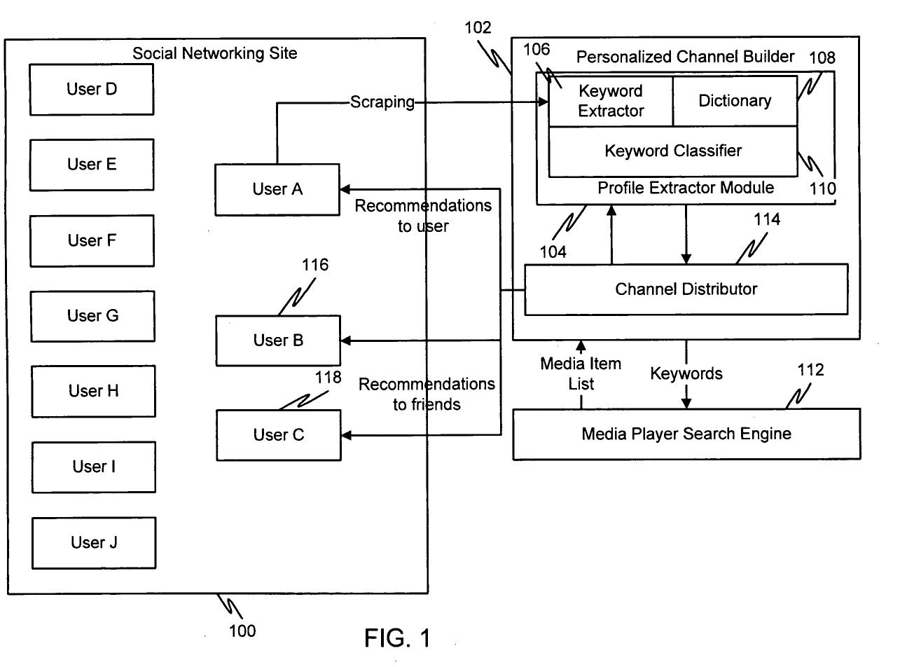

FIG. 1 is a block diagram illustrating an architecture for creating a personalized video channel in accordance with an embodiment of the present invention. A social networking site 100 may comprise millions of users. A personalized channel builder 102 interfaces with the social networking site 100 to create the video channel. Specifically, a profile extractor module 104 uses web-scrapping or an interface provided by the social networking site 100 to access information about users. While user profile information is considered to be a prime example of information that would be helpful in creating a video channel personalized to a user, nothing in this disclosure should be read as limiting the information merely to a user profile. Other information gathered through the social networking site 100 may be relevant to the personalization of the video channel as well. These include, but are not limited to, messages exchanged with other users on the social networking sites, tags used by the user to label web pages, images, videos, etc., resources belonging to other users, and other applications, including third party applications (i.e., not created by the social networking site), on the social networking site 100.

The profile extractor module 104 then analyzes the information gathered from one or more of the above sources and extracts relevant keywords. A keyword extractor module 106 within the profile extractor module 104 consults a dictionary 108 to remove unimportant words while trying to identify good keywords from the information. One technique for doing to is to find proper nouns, i.e., specific names of persons, places, or things found in the information. Picking good keywords helps to improve the quality of the video search results. While a user profile often has areas where common nouns are listed in a straightforward manner (e.g., a comma-delimited list of favorite bands), other areas of the profile are more ambiguously worded, such as a user's essay on his or her own personality.

The profile extractor module 104 also contains a keyword classifier 110 that labels the keywords extracted from the various sources. For example, users might explicitly state their music interests in a social networking site or might explicitly express movie directors they like. The keyword classifier 110 labels the various extracted keywords with labels that classify the type of information. This allows the system to not only search for videos based on extracted keywords, but also on the categories under which the keywords fall. For example, a keyword extracted might be “Superman”, which can then be classified under the category “Fantasy Movies” or “Comic Books.” A subsequent search of videos may then be able to retrieve not only videos related to Superman but also other Fantasy Movie characters such as Bilbo Baggins or other comic book characters such as Wonder Woman.

The type of the information may also be used to aid in the accuracy of the search. For example, the term “David Copperfield” may apply to English Literature or magicians. Other keywords in the same profile might, however, provide clarification about which “David Copperfield” the user has interest. For example, the user may also list “A Tale of Two Cities” and “A Christmas Carol”, and thus a subsequent search may be focused on English Literature.

Keywords labeled with classifiers are then forwarded to a video search engine 112, which then returns a list of matching videos. The video search engine 112 can consult multiple databases and web sites to locate matching videos. The matching videos then are packaged as a list or channel by a channel distributor 114 and provided to the user. If the user chooses to share this video list then the list of forwarded to the user's friends 116, 118. The channel distributor 114 finds the location of delivery from information extracted by the profile extractor module 104.

It should be noted that the present invention is not limited to using the list of videos within the social networking site. For example, the list of personalized videos can be forwarded to a different web site or to a device owned by the user. Specifically, examples are foreseen wherein the list of videos is forwarded to a set-top box connected to a television, allowing for a personalized video channel to be retrieved for play on the user's television. Likewise, the list may be forwarded to another media player such as a user's portable device.

In another embodiment of the present invention, information other than that retrieved from a social networking site or not traditionally associated with social networking sites is combined with information from one or more of the social networking sources listed above. In one example, information regarding the user's location and or current status (e.g., at home versus at work) is used in compiling the list of videos. Many users of social networking sites use the sites for both personal and business uses. For example, linked “friends” on a social networking site may not just be merely social friends or acquaintances, but may also be business contacts, clients, etc. The user's profile and social networking activities may then also contain information that is relevant to either personal or business uses. If a user is at work, he or she may not wish to see a video channel that is drawn from information on his or her personal life, and likewise a user at home may wish to get a break from work-related information and may prefer to watch videos solely drawn from information about his or her personal life. Thus, by examining the location or status for the user, the video personalization may be made more effective. Other than location and status, other factors may be utilized in making the determination of the list of videos in the video channel, including, but not limited to, time of day, user's vacation status, location of the media device upon which the videos will play (e.g., bedroom versus kitchen), etc.

Furthermore, while the present document, including the title of the present invention, imply that the invention may be limited to videos, embodiments are foreseen wherein the techniques described herein are applied to other media, such as books, audio (including musical and spoken works) and images. The term “media” shall be construed as applying to at least these other types of media and should not be limited to videos unless explicitly stated. “Media items” refer to individual instances of media. For example, a book, video, or song is a media item.

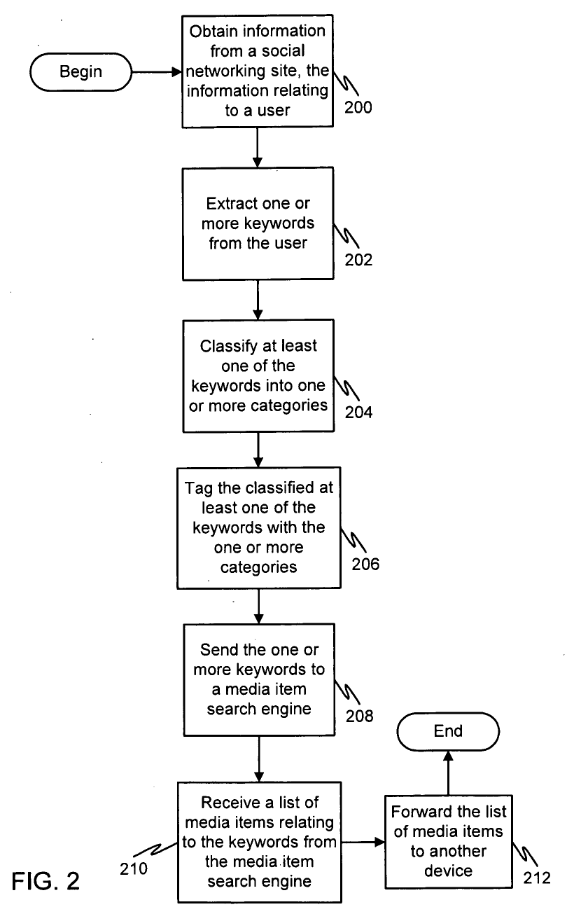

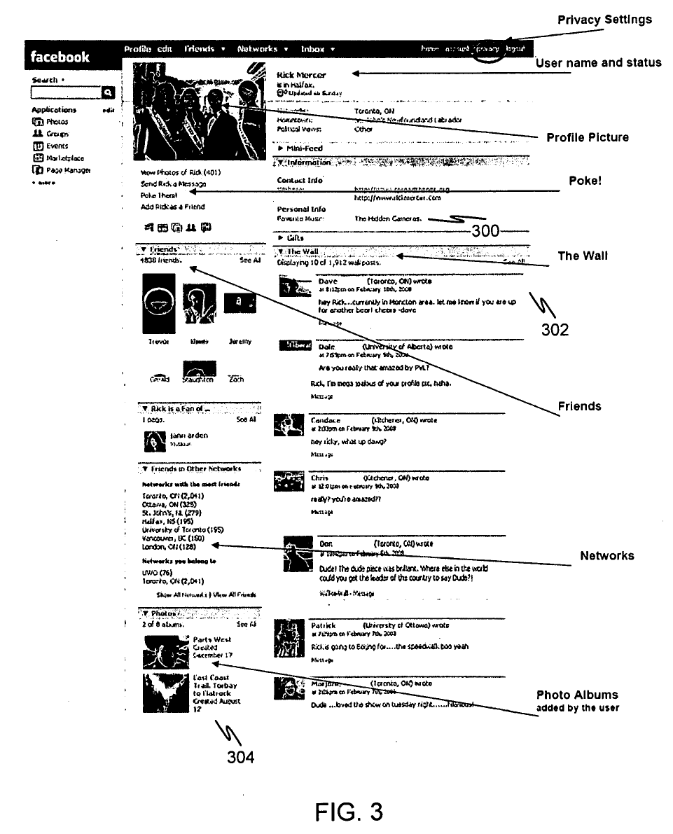

FIG. 2 is a flow diagram illustrating a method for automatically creating a list of media items for a user in accordance with an embodiment of the present invention. At 200, information is obtained from a social networking site, the information relating to a user. This information may be at least partially extracted from a social networking site profile for the user, but may also include information obtained from social networking site communications to and from the user, information obtained from tags used by the user to label web pages and/or media items, and information obtained from third party applications. At 202, one or more keywords are extracted from the information. This may include comparing retrieved text to a dictionary and identifying proper nouns from the information and using the proper nouns as keywords. One embodiment of such a process may be found in the dictionary comparison of U.S. patent application Ser. No. 11,821,938, entitled “METHOD AND SYSTEM FOR EXTRACTING RELEVANT INFORMATION FROM CONTENT METADATA,” by Priyang Rathod, Phuong Nguyen, Anugeetha Kunjithapatham, Mithun Sheshagiri, and Alan Messer, filed Jun. 26, 2007, herein incorporated by reference in its entirety for all purposes. At 204, at least one of the keywords may be classified into one or more categories. At 206, the classified at least one of the keywords may be tagged with the one or more categories. At 208, the one or more keywords are sent to a media item search engine. This sending may include sending a first set of keywords to the media item search engine if the user has a first status and a second set of keywords to the media item search engine if the user has a second status. The first and second status may be home/work. At 210, a list of media items relating to the keywords are received from the media item search engine. The media items may be videos. At 212, the list of media items may be forwarded to another device, such as a set-top box.

FIG. 3 is an example screenshot of a sample social networking site profile. Here, the social networking site is Facebook. The user profile may include textual information labeled “personal info” 300, which may be very useful in extracting keywords related to the user's interests. Other areas where relevant keywords can be extracted include “The Wall” 302, which is an area where friends can post messages and replies for the user, and the photo album 304, where the user can add photos and tag the photos with text, text that may provide valuable keywords for the present invention.

An embodiment is foreseen wherein a set of computer instructions are tangibly embodied in a program storage device, the set of computer instructions readable by a machine and executable by the machine to perform some or all of the processes described above. Such a program storage device would include tangible items such as a computer disk, hard drive, or Random Access Memory (RAM), but would not include intangible items such as electrical signals.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A method for automatically creating a list of media items for a user, the method comprising:
obtaining information relating to the user from a social networking site;
extracting one or more keywords from the information;
sending the one or more keywords to a media item search engine; and
receiving a list of media items relating to the keywords from the media item search engine.

2. The method of claim 1, wherein the information is at least partially extracted from a social networking site profile for the user.

3. The method of claim 2, wherein the information includes information obtained from social networking site communications to and from the user.

4. The method of claim 2, wherein the information includes information obtained from tags used by the user to label web pages and/or media items.

5. The method of claim 2, wherein the information includes information obtained from a third party application.

6. The method of claim 1, wherein the media items are videos.

7. The method of claim 1, wherein the extracting includes comparing retrieved text to a dictionary.

8. The method of claim 7, wherein the extracting further includes identifying proper nouns from the information and using the proper nouns as keywords.

9. The method of claim 1, further comprising:
classifying at least one of the keywords into one or more categories; and
tagging the classified at least one of the keywords with the one or more categories.

10. The method of claim 1, wherein the sending comprises sending a first set of keywords to the media item search engine if the user has a first status and a second set of keywords to the media item search engine if the user has a second status.

11. The method of claim 10, wherein the first status is that the user is at work and the second status is that the user is at home.

12. The method of claim 1, further comprising forwarding the list of media items to a set-top box.

13. An apparatus for automatically creating a list of media items for a user, the apparatus comprising:
a personalized channel builder communicatively coupled to a video search engine and to a social networking site, the personalized channel builder comprising:
a profile extractor; and
a channel distributor.

14. The apparatus of claim 13, wherein the profile extractor includes:
a keyword extractor; and
a keyword classifier.

15. The apparatus of claim 14, wherein the keyword extractor is capable of accessing a dictionary.

16. An apparatus for automatically creating a list of media items for a user, the apparatus comprising:
means for obtaining information relating to the user from a social networking site;
means for extracting one or more keywords from the information;
means for sending the one or more keywords to a media item search engine; and
means for receiving a list of media items relating to the keywords from the media item search engine.

17. The apparatus of claim 16, wherein the means for extracting includes means for comparing retrieved text to a dictionary.

18. The apparatus of claim 17, wherein the means for extracting further includes means for identifying proper nouns from the information and using the proper nouns as keywords.

19. The apparatus of claim 16, further comprising:
means for classifying at least one of the keywords into one or more categories; and
means for tagging the classified at least one of the keywords with the one or more categories.

20. A program storage device readable by a machine tangibly embodying a program of instructions executable by the machine to perform a method for automatically creating a list of media items for a user, the method comprising:
obtaining information relating to the user from a social networking site;
extracting one or more keywords from the information;
sending the one or more keywords to a media item search engine; and
receiving a list of media items relating to the keywords from the media item search engine.
